(19) United States
(12) Patent Application Publication
(10) Pub. No.: US 2006/0268140 A1
(43) Pub. Date: Nov. 30, 2006

(54) Method and apparatus for reducing noise in analog amplifier circuits and solid state imagers employing such circuits

(75) Inventors: Leonard Forbes, Corvallis, OR (US); David Cuthbert, Meridian, ID (US)

Correspondence Address: DICKSTEIN SHAPIRO LLP, 1825 EYE STREET NW, Washington, DC, 20006-5403, US

(73) Assignee: Micron Technology, Inc.

(21) Appl. No.: 11/135,520

(22) Filed: May 24, 2005

(51) Int. Cl. H04N 5/335

(52) U.S. Cl. 348/300

(57) ABSTRACT

A technique for reducing 1/f noise in an imager, in which the source follower transistor in a pixel circuit is turned off prior to a correlated double sampling (CDS) operation, thereby reducing 1/f noise in the source follower transistor for up to 100 ms. The source follower transistor is then reactivated and a CDS operation and readout is performed normally. This technique substantially reduces the contributions of 1/f noise. The invention also provides a reduction of 1/f noise in an analog amplifier circuit which may process pixel output signals, or more generally, other analog signals, whereby the analog amplifier is turned off during an amplifier reset operation prior to signal amplification. The analog amplifier circuit may be a differential amplifier or a switched capacitor analog amplifier circuit.

### FIELD OF THE INVENTION

The present invention relates generally to complementary metal oxide semiconductor (CMOS) imagers, and more particularly to noise reduction circuits for use with CMOS imager pixels and differential amplifiers. It also relates to noise reduction circuits in differential amplifiers and in analog amplifiers generally.

### BACKGROUND OF THE INVENTION

Image sensors are used in a variety of digital image capture systems, including products such as scanners, copiers, and digital cameras. The image sensor is typically composed of an array of light-sensitive pixel cells that are electrically responsive to incident light reflected from an object or scene whose image is to be captured.

A CMOS imager includes a focal plane array of pixel cells, each cell includes a photosensor, for example, a photogate, photoconductor or a photodiode overlying a substrate for producing a photo-generated charge in a doped region of the substrate. In a CMOS imager, the active elements of a pixel cell, for example a four transistor (4T) pixel cell, perform the necessary functions of (1) photon to charge conversion; (2) resetting a floating diffusion region to a known state; (3) transfer of charge to the floating diffusion region; (4) selection of a pixel cell for readout; and (5) output and amplification of a signal representing a reset voltage and a pixel signal voltage based on the photo-converted charges. The charge at the floating diffusion region is converted to a pixel or reset output voltage by a source follower output transistor.

Exemplary CMOS imaging circuits, processing steps thereof, and detailed descriptions of the functions of various CMOS elements of an imaging circuit are described, for example, in U.S. Pat. No. 6,140,630, U.S. Pat. No. 6,376,868, U.S. Pat. No. 6,310,366, U.S. Pat. No. 6,326,652, U.S. Pat. No. 6,204,524, and U.S. Pat. No. 6,333,205, all assigned to Micron Technology, Inc. The disclosures of each of the forgoing patents are hereby incorporated by reference herein in their entirety.

A schematic diagram of a conventional CMOS four-transistor (4T) pixel cell 10 is illustrated in FIGS. 1(a) and 1(b). FIG. 1(a) is a top-down view of the active area of the cell 10; FIG. 1(b) is an electrical schematic of the cell 10 of FIG. 1(a). The illustrated cell 10 includes a pinned photodiode 13 as a photosensor. Alternatively, the CMOS cell 10 may include a photogate, photoconductor or other photon-to-charge converting device, in lieu of the pinned photodiode 13, as the initial accumulating area for photo-generated charge. The photodiode 13 includes a p+ surface accumulation layer and an underlying n-charge accumulation region formed in a p-type semiconductor substrate layer 2.

The pixel cell 10 has a transfer gate 7, which is part of a transfer transistor 8, for transferring photocharges generated in the n-accumulation region to a floating diffusion region 3. The floating diffusion region 3 is further connected to a gate 27 of a source follower transistor 28. The source follower transistor 28 provides an output signal to a row select transistor 38 having a gate 37 for selectively gating the output signal to a column line 50. The column line 50 is selected for readout by a column select transistor 52, which applies a current source 54 to column line 50. A reset transistor 18 having a gate 17 resets the floating diffusion region 3 to a specified charge level by connecting it to a supply voltage Vₐₐ₋ₚᵢₓ before each charge transfer from the n-accumulation region of the photodiode 13.

FIG. 1(b) also shows additional pixel cells 10_{N} from other rows of a pixel array connected to column line 50. FIG. 1(b) also shows a portion of the pixel readout circuit, including a sample and hold circuit 161 and a differential amplifier circuit 162 which are explained in greater detail with respect to FIG. 1(c).

The performance of an image capture system depends in large part on the quantum efficiency of each individual pixel cell 10 in the sensor array and readout circuits and their immunity from noise. Many techniques are employed to increase the noise immunity.

FIG. 1(c) illustrates a block diagram of an exemplary CMOS imager 108 having a pixel array 140 comprising a plurality of pixel cells 10 arranged in a predetermined number of columns and rows, with each pixel cell being constructed as illustrated and described above with respect to FIGS. 1(a) and 1(b). Attached to the array 140 is signal processing circuitry, as described herein, at least part of which may be formed in the substrate. The pixel cells of each row in array 140 are all turned on at the same time by row actuation lines, and the pixel cells of each column are selectively output by respective column select lines through column select transistor 52. A plurality of row and column lines are provided for the entire array 140. The row lines are selectively activated by a row driver 145 in response to row address decoder 155. The column select lines are selectively activated by a column driver 160 in response to column address decoder 170. Thus, a row and column address is provided for each pixel cell.

The CMOS imager 108 is operated by a timing and control circuit 150, which controls address decoders 155, 170 for selecting the appropriate row and column lines for pixel readout. The control circuit 150 also controls the row and column driver circuitry 145, 160 such that they apply driving voltages to the drive transistors of the selected row and column lines. The pixel column signals, which typically include a pixel reset signal Vᵣₛₜ produced when reset transistor 18 resets floating diffusion region 3, and a pixel image signal V_{sig}, produced when charges are transferred to the floating diffusion region 3 by transfer transistor 8 from photosensor 13. The charge stored in each floating diffusion region 3 is applied to the gate 27 of source follower transistor 28. These signals are read by a sample and hold circuit 161. Vᵣₛₜ is produced by source follower transistor 28 and read from a pixel cell 10 immediately after a floating diffusion region 3 is reset by the reset transistor 18. V_{sig} represents the amount of charge generated by the photosensitive element of the pixel cell 10 in response to applied light. A differential signal (Vᵣₛₜ−V_{sig}) is produced by differential amplifier 162 from the sampled and held Vᵣₛₜ and V_{sig} signals and is produced by source follower transistor 28 after charge is transferred from the photosensor 13 to the floating diffusion region 3 by the transfer transistor 8 for each pixel cell in a given frame. This process of sampling Vᵣₛₜ and V_{sig} in a single frame is known as correlated double sampling (“CDS”). The differential signal is digitized by an analog-to-digital converter 175 (ADC). The analog to digital converter 175 supplies the digitized pixel signals to an image processor 180, which forms and outputs a digital image.

Correlated double sampling (“CDS”) is a common technique for reducing noise in CMOS imager sensors, as well as in CCD image sensors, memory circuits, and analog signal processing circuits. Because both Vᵣₛₜ and V_{sig} contain the contributions of noise, CDS can eliminate, for the most part, fixed common pattern and other noise in imagers.

One type of noise, referred to as “1/f flicker noise,” where f is the frequency in Hertz, is caused by the devices used in the pixel cell 10, and is thought to be caused by traps in the gate oxide of an amplifying transistor, e.g., source follower transistor 28, which capture and emit channel carriers. Since 1/f noise is inversely proportional to frequency, as shown in FIG. 6(a), it can be the dominant noise mechanism at lower frequencies and can be a significant source of noise well into the megahertz range.

Conventional correlated double sampling can reduce 1/f noise, but to a lesser extent. Referring now to FIG. 6(b), 1/f noise can vary slowly, with no detectable change over as many as 100 milliseconds, and then jump abruptly. When the CDS sampling period is contained entirely between jumps, as with CDS period A-B, the 1/f noise can be effectively cancelled out during CDS. However, if the CDS sampling period spans one of these jumps, as with CDS period B-C, the 1/f noise remains in and distorts the output signal thereby distorting the image. As the sampling period increases, the effect of 1/f noise also increases, as shown in FIG. 6(c).

1/f noise may be reduced by using larger source follower transistor devices, but this is not feasible in array type applications, such as an array of CMOS imaging pixel cells, where space utilized by each element must be very small, as with an array of CMOS imaging pixel cells.

Noise also occurs in solid state imagers, e.g, CMOS imagers, and in switched capacitor analog amplifier circuits. In addition, the amplifier has thermal noise as well as 1/f device noise. The performance of these analog amplifiers also depends in large part on their immunity from noise. Many techniques are employed to increase noise immunity.

Since the sizes of the electrical signals generated by any given pixel cell in a CMOS imager are very small, it is especially important for the signal to noise ratio of the pixel cell to be as high as possible. Generally speaking, these desired features are not attainable, however, without additional devices that increase the size of the pixel cell. Therefore, there is a need and desire for an improved circuitry for use in an imager that provides a high signal to noise ratio while maintaining a small device size.

### BRIEF SUMMARY OF THE INVENTION

The present invention provides, as illustrated in one exemplary embodiment, a technique for reducing 1/f noise in an imager. The source follower transistor in a pixel circuit is turned off prior to a correlated double sampling (CDS) reset operation, thereby reducing 1/f noise in the source follower transistor for up to 100 ms. The source follower transistor is then reactivated and a CDS operation and readout is performed normally. This technique substantially reduces the contributions of 1/f noise.

The invention also provides, in other exemplary embodiments, a reduction of 1/f noise and other noise in an analog amplifier circuit which may process pixel output signals, or more generally, other analog signals, whereby the analog amplifier is turned off during an amplifier reset operation. The analog amplifier circuit may be a switched capacitor analog amplifier circuit.

The pixel signal and amplifier noise reducing exemplary embodiments may be used individually or in combination in a solid state imaging device.

### BRIEF DESCRIPTION OF THE DRAWINGS

The foregoing and other advantages and features of the invention will become more apparent from the detailed description of exemplary embodiments provided below with reference to the accompanying drawings in which:

FIG. 1(a) is a top-down view of a conventional pixel cell;

FIG. 1(b) is an electrical schematic of the conventional pixel cell of FIG. 1(a) and a portion of its readout circuit;

FIG. 1(c) depicts a block diagram of an imager device which may employ the present invention;

FIG. 2 is an electrical schematic of the a pixel cell showing a method for resetting the source follower transistor in accordance with the present invention;

FIG. 3(a) is a schematic of a CMOS differential amplifier showing a method for resetting amplifying transistors in accordance with the present invention;

FIG. 3(b) shows an alternate technique for resetting the amplifying transistors of FIG. 3(a) in accordance with the present invention;

FIG. 4(a) is a conventional switched capacitor amplifier;

FIG. 4(b) is a switched capacitor amplifier in accordance with the present invention;

FIG. 5 shows a processor system incorporating at least one imager device constructed in accordance with an embodiment of the invention;

FIG. 6(a) shows the relationships between frequency and different types of noise, which may be present in an imaging circuit;

FIG. 6(b) shows the effects of 1/f noise on CDS applications; and

FIG. 6(c) shows the effects of 1/f noise as CDS sampling times increase;

### DETAILED DESCRIPTION OF THE INVENTION

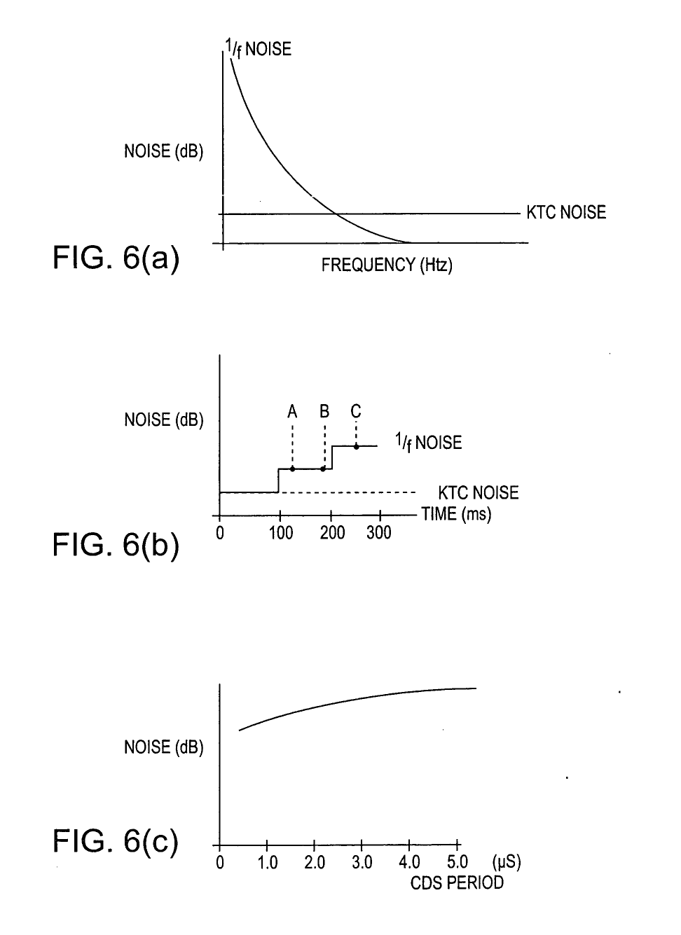

As shown in FIG. 6(b) and as discussed above, 1/f noise may abrubtly increase in the interval between the measurement of reset voltage Vᵣₛₜ and photosignal voltage V_{sig}. When 1/f noise increases in this manner, the CDS result can be distorted by the additional 1/f noise in the photosignal V_{sig}.

However, there is a lag time of up to 100 milliseconds after powering up a field effect transistor (“FET”) before 1/f noise appears in the transistor, as shown in FIG. 6(b). Resetting the gate to source voltage of any amplifying transistor to zero during the reset operation eliminates 1/f noise in the transistor long enough to perform a CDS operation.

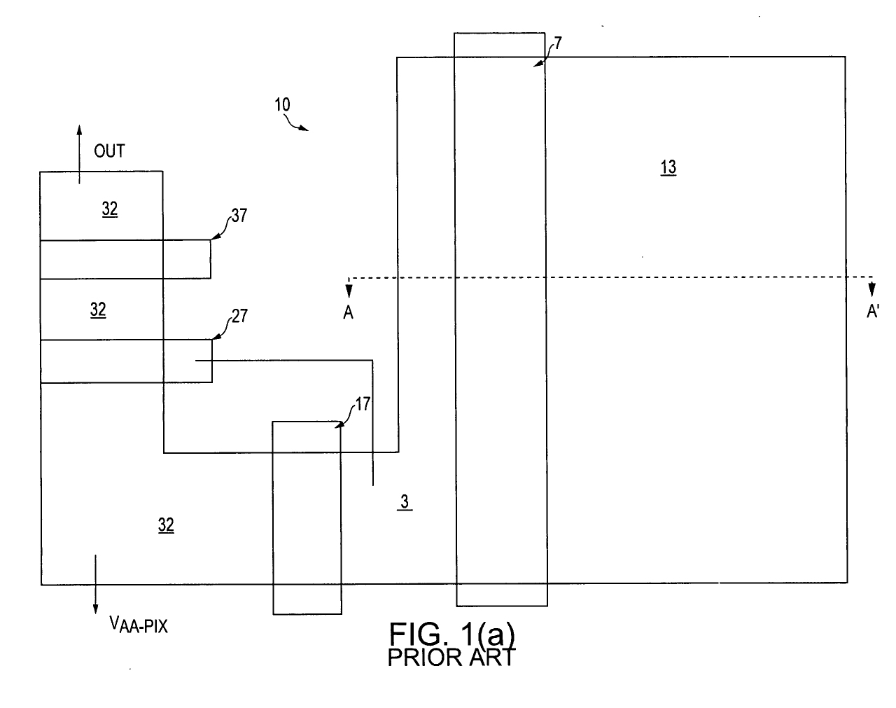

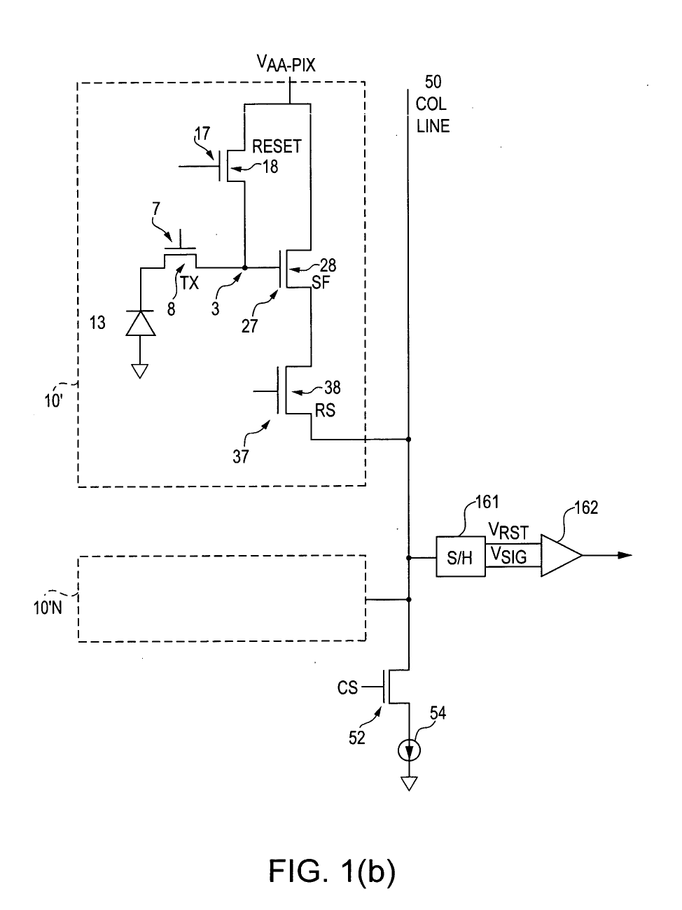

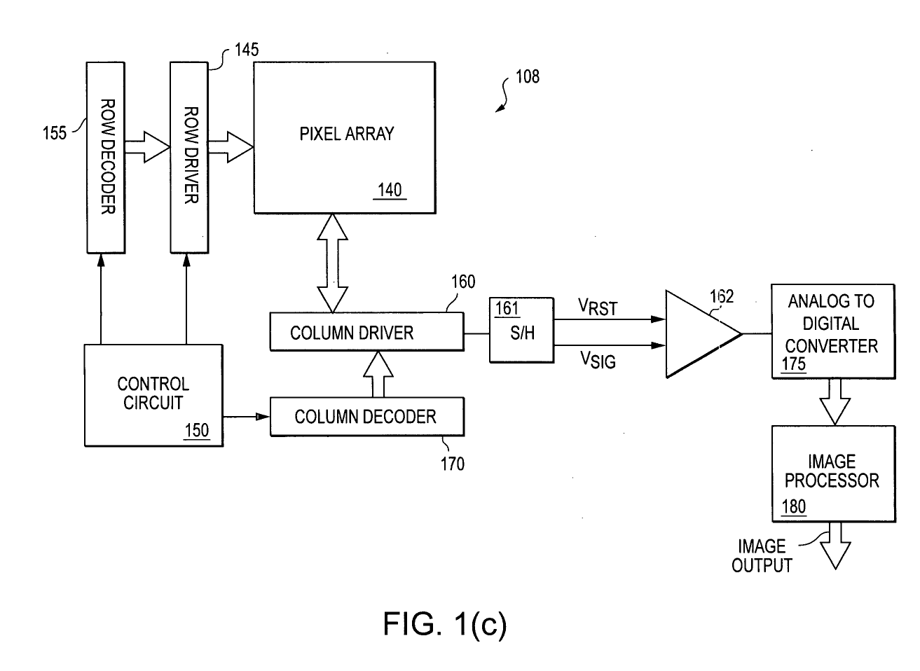

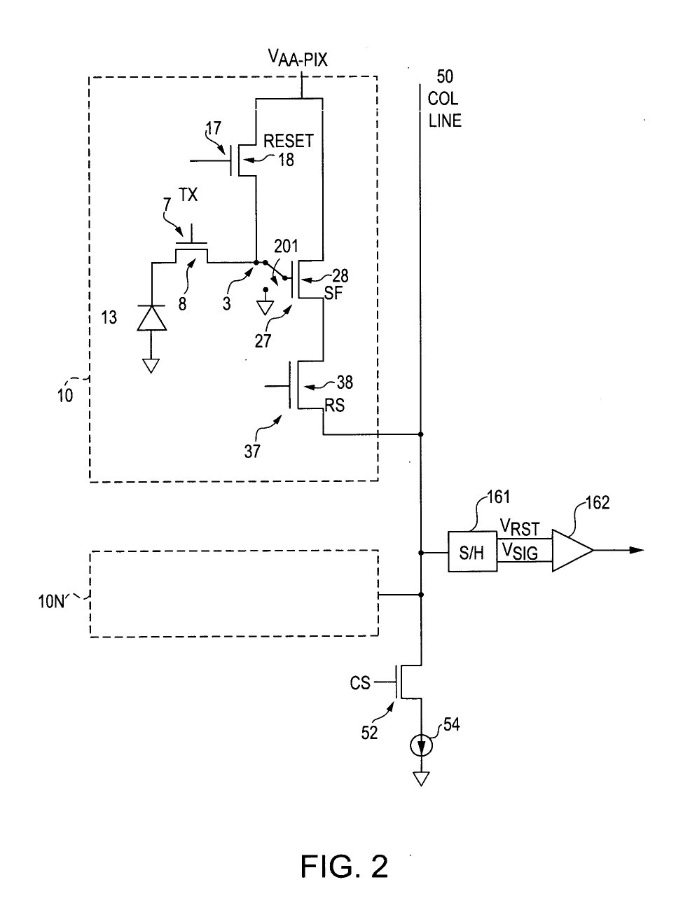

According to an exemplary embodiment of the invention, a method for resetting the source follower transistor of a pixel cell in accordance with the present invention is shown in FIG. 2. Pixel cell 10′ (and other pixel cells 10_{N}′ from other rows of the array) includes all of the elements contained in conventional pixel cell 10 (shown in FIG. 1(c)), and additionally includes switch 201, which can be a transistor switch, connected between floating diffusion region 3 and the gate 27 of source follower transistor 28.

As described above, the pixel column signals, Vᵣₛₜ and V_{sig}, are produced by the charges stored in each floating diffusion region 3 which are applied to the gate 27 of source follower transistor 28. Vᵣₛₜ is produced by source follower transistor 28 and read by the sample and hold circuit 161 immediately after a floating diffusion region 3 is reset by the reset transistor 18.

According to the present invention, immediately before V_{sig} is read out by the sample and hold circuit 161, switch 201 sets the gate 27 of source follower transistor 28 to ground, deactivating the source follower transistor 28 without discharging the floating diffusion region 3. Switch 201 then immediately reactivates source follower transistor 28 so that V_{sig} may be read out by sample and hold circuit 161. By deactivating source follower transistor 28 immediately before reading out V_{sig}, the contribution of 1/f noise to V_{sig} from source follower transistor 28 will be significantly reduced, allowing for a more accurate CDS result.

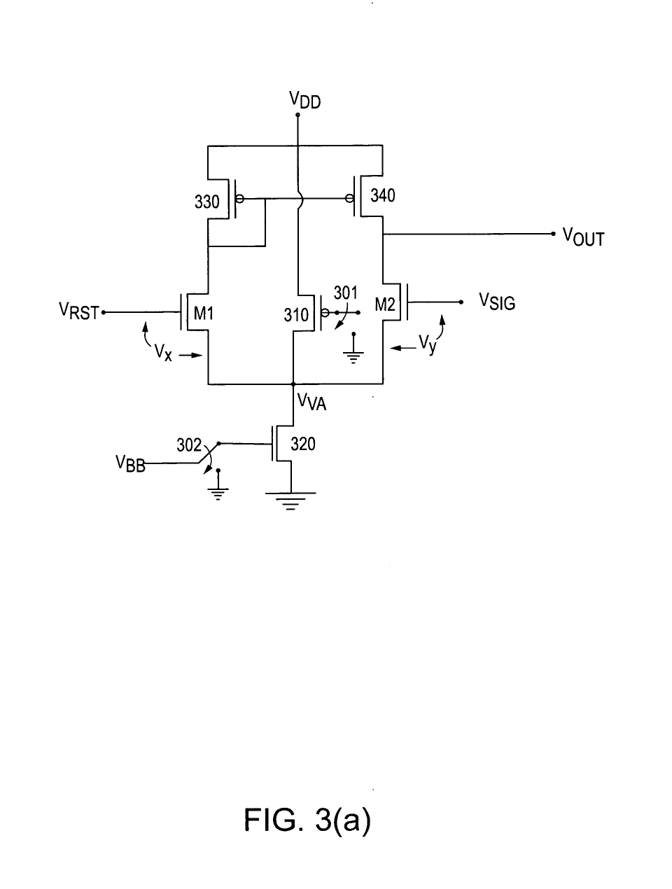

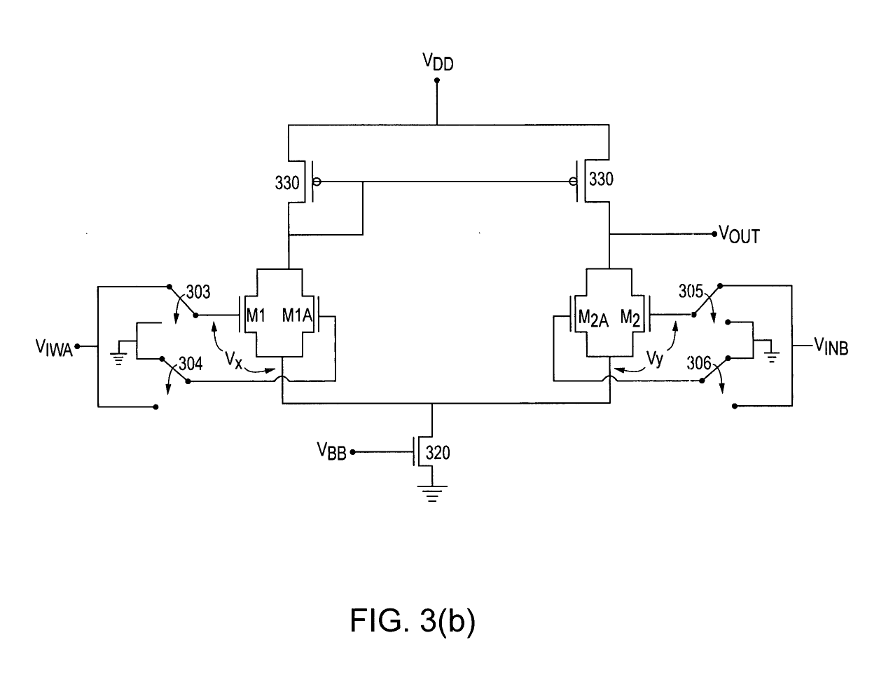

According to another exemplary embodiment of the present invention, a CMOS differential amplifier, which may be used for differential amplifier 162 (see FIG. 1(c)), is shown in FIG. 3(a). The amplifier includes transistors Ml, MN, 310, 320, 330, 340, and switches 301, 302 which may be transistor switches. Switch 301 is configured to ground the gate node of transistor 310. Switch 302 is configured to simultaneously switch off current sink transistor 320 when switch 301 grounds the gate of transistor 310. Transistor M₁, having gate to source voltage Vₓ, receives and transmits a signal representing an applied reset voltage Vᵣₛₜ to transistor 330. Transistor M₂, having gate to source voltage V_{y}, receives and transmits a signal representing a photosignal voltage V_{sig}, generated by a photosensor, to transistor 340. Node voltages V_{DD} and V_{BB} represent the power supply voltages and V_{VG} is a node voltage at the source node of current sink transistor 320. Vₒᵤₜ represents an amplified output voltage.

Differential amplifier 162 receives reset voltage Vᵣₛₜ and photosignal voltage V_{sig} from sample and hold circuit 161. The difference (Vᵣₛₜ−V_{sig}) is amplified and output as Vₒᵤₜ. The differential amplifier can introduce 1/f noise into V_{sig} and Vᵣₛₜ as well, through amplifying transistors M₁ and M₂.

To counteract the introduction of 1/f noise by transistors M₁ and M₂, transistors M₁ and M₂ are reset immediately before Vᵣₛₜ and V_{sig} are received by the differential amplifier 162 from the sample and hold circuit 161. During reset of transistors M₁ and M₂, the transistors M₁ and M₂ are first switched off so that they both have a zero or negative gate to source voltage (Vₓ and V_{y} respectively). A PMOS reset transistor 310 switches transistors M₁ and M₂ off by equalizing node voltages V_{DD} and V_{VG} and creating a positive source voltage for transistors M₁ and M₂. The positive source voltage creates gate to source voltages Vₓ and V_{y} having zero or negative values for amplifying transistors M₁ and M₂ respectively. At the same time, the current sink transistor 320 is also switched off by throwing switch 302 to ground to prevent overloading the circuit during reset. Transistors M₁ and M₂ are then switched back on by deactivating reset transistor 310 and reactivating current sink transistor 320. Vᵣₛₜ and V_{sig} are then received by the differential amplifier 162 from the sample and hold circuit 161 and a differential result (Vᵣₛₜ−V_{sig}) is produced by the differential amplifier 162. By resetting transistors M₁ and M₂ prior to receiving V_{sig} and Vᵣₛₜ from the sample and hold circuit 161, the contribution of 1/f noise to V_{sig} and Vᵣₛₜ from transistors M₁ and M₂ is significantly reduced.

However, switching the entire amplifier circuit off during each CDS cycle is not the most desirable approach. For example, some devices may exhibit railing, a delay in start-up, or thermal tails. An alternate exemplary embodiment addressing this problem is shown in FIG. 3(b). FIG. 3(b) includes additional transistors M_{1A}, M_{2A}, and switches 303, 304, 305, 306, which may be transistor switches. Transistor 310 and switches 301 and 302, from the FIG. 3(a) embodiment, are omitted from the FIG. 3(b) embodiment.

In the alternate embodiment shown in FIG. 3(b), M₁ and M₂ are also reset before the differential amplifier receives V_{sig} and Vᵣₛₜ from the sample and hold circuit 161. However, in this alternate embodiment, M₁ and M₂ are reset without switching off the entire circuit. As shown in FIG. 3(b), during reset of transistors M₁ and M₂, switch 303 deactivates transistor M₁ while switch 304 simultaneously activates transistor M_{1A}. Likewise, switch 305 is deactivates transistor M₂ while switch 306 simultaneously activates transistor M_{2A}, thereby setting the gate to source voltages Vₓ and V_{y} to zero or a negative value without deactivating the entire circuit. Transistors M1 and M2 are then reactivated and transistors M1A and M2A are simultaneously deactivated. The differential amplifier 162 then receives Vᵣₛₜ and V_{sig} from the sample and hold circuit 161.

Because this operation allows amplifying transistors M_{1A} and M_{2A} to be powered down while maintaining the amplifier 162 in an operational state, a complete restart of the amplifier 162 is avoided, and none of the problems associated with the embodiment shown in FIG. 3(a), e.g., railing, a delay in start-up, thermal tails, etc., are present in this embodiment. This operation reduces 1/f noise in amplifying transistors M₁ and M₂ long enough to perform a more accurate differential comparison of Vᵣₛₜ and V_{sig} by preventing the introduction of additional 1/f noise from amplifying transistors M₁ and M₂.

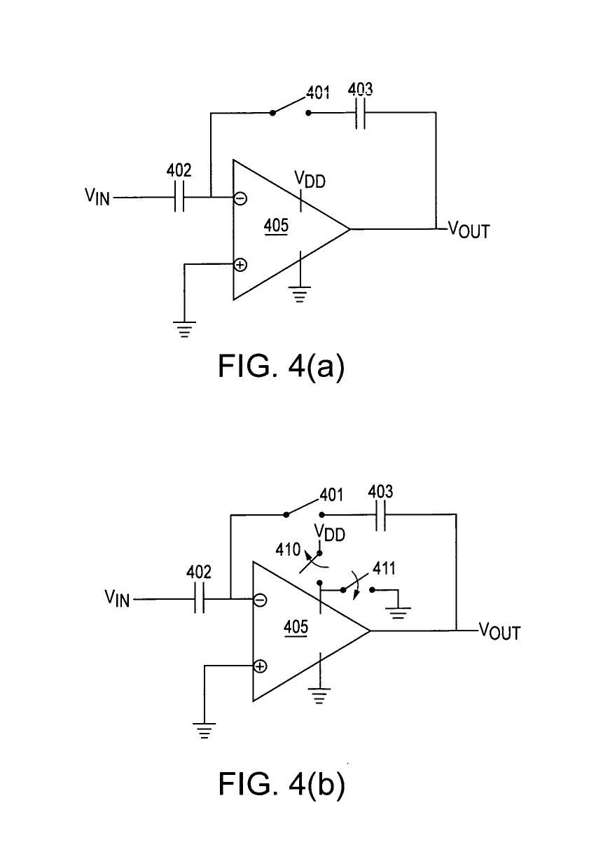

More generally, the technique of turning off an amplifier prior to a noise sensitive operation can temporarily reduce 1/f noise in many different kinds of analog amplifiers. A conventional switched capacitor analog amplifier 405 is shown in FIG. 4(a). The amplifier 405 includes capacitors 402, 403, and switch 401. Switch 401 operates in conjunction with capacitors 402 and 403 to produce an amplified voltage Vₒᵤₜ from input voltage Vᵢₙ. The amplifier 405 operates from a constant voltage source V_{DD}.

However, as discussed above, Vₒᵤₜ also contains contributions from 1/f noise, which can overwhelm the desired output signal at low frequencies.

A switched capacitor analog amplifier constructed in accordance with the present invention is shown in FIG. 4(b), and contains additional switches 410, 411. According to the embodiment shown in FIG. 4(b), V_{DD} is switched off prior to an amplification operation. A first switch 410 breaks the connection of the amplifier to source V_{DD} while a second switch 411 grounds the amplifier. By switching off V_{DD} prior to an amplification operation, 1/f noise can be reduced long enough to take a more noise-free amplified signal Vₒᵤₜ.

It should be noted that the single input amplifier illustrated in FIG. 4(b) may also be used in an imager device to amplify the Vᵣₛₜ and V_{sig} analog signals prior to subtraction in differential amplifier 162, or to amplify the differential result (Vᵣₛₜ−V_{sig}) prior to analog to digital conversion by converter 175.

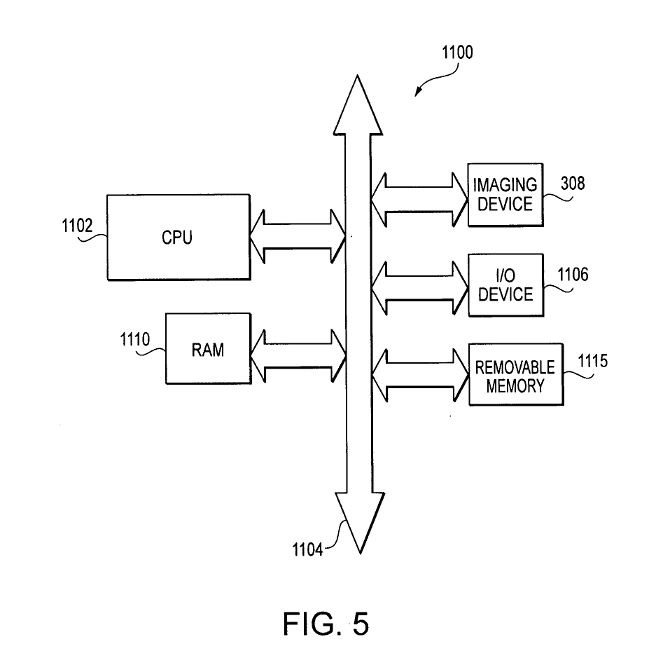

FIG. 5 illustrates a processor-based system 1100 including an imaging device 308, CPU 1102, RAM 1110, I/O device 1106, and removable memory 1115. The imaging device 308 has circuitry constructed in accordance with the methods as described herein. For example, the differential amplifier 162 may be the exemplary differential amplifier constructed in accordance with the exemplary embodiments of the invention described above and/or the pixel circuits of the imager array may include an exemplary embodiment of the FIG. 2 circuit.

The processor-based system 1100 is exemplary of a system having digital circuits that could include image sensor devices. Without being limiting, such a system could include a computer system, camera system, scanner, machine vision, vehicle navigation, video phone, surveillance system, auto focus system, star tracker system, motion detection system, image stabilization system, data compression system and other image processing system.

The processor-based system 1100, for example a camera system, generally comprises a central processing unit (CPU) 1102, such as a microprocessor, that communicates with an input/output (I/O) device 1106 over a bus 1104. Imaging device 308 also communicates with the CPU 1102 over the bus 1104. The processor-based system 1100 also includes random access memory (RAM) 1110, and can include removable memory 1115, such as flash memory, which also communicates with CPU 1102 over the bus 1104. Imaging device 308 may be combined with a processor, such as a CPU, digital signal processor, or microprocessor, with or without memory storage on a single integrated circuit or on a different chip than the processor. Any of the memory storage devices in the processor-based system 1100 could store software for employing the above-described method.

The above description and drawings are only to be considered illustrative of exemplary embodiments which achieve the features and advantages of the invention. Modification of, and substitutions to, specific process conditions and structures can be made without departing from the spirit and scope of the invention. Accordingly, the invention is not to be considered as being limited by the foregoing description and drawings, but is only limited by the scope of the appended claims.

1. An imager circuit comprising:
a pixel comprising structure for providing a signal representing a pixel output voltage:
an amplifier circuit for receiving a signal representing said pixel output voltage; and
a switch circuit for pre-biasing said amplifier circuit prior to amplifying said signal representing said pixel output voltage such that, when said pre-biasing is performed and said signal representing said pixel output voltage is amplified by said amplifier circuit, noise in said amplifier circuit is reduced.

2. The imager circuit according to claim 1, wherein said amplifier circuit comprises a source follower circuit having a source follower transistor.

3. The imager circuit according to claim 2, wherein said switch circuit is configured to pre-bias said amplifier circuit by:
switching off said source follower transistor; and
switching on said source follower transistor prior to said source follower circuit amplifying said signal representing said pixel output voltage.

4. The imager circuit according to claim 1, wherein said amplifier circuit comprises a differential amplifier, said differential amplifier comprising
a differential circuit portion;
a first amplifying transistor coupled to said differential circuit portion and configured to receive and amplify a first signal representing said pixel image voltage; and
a second amplifying transistor coupled to said differential circuit portion and configured to receive and amplify a second signal representing said pixel reset voltage.

5. The imager circuit according to claim 4, wherein said switch circuit is configured to pre-bias said amplifier circuit by:
switching off said first and second amplifying transistors; and
switching on said first and second amplifying transistors, prior to said amplifying said pixel image voltage and said pixel reset voltage.

6. The imager circuit according to claim 5, wherein said differential amplifier further comprises:
a third transistor connected in parallel with said first amplifying transistor, said third transistor being configured to turn on when said first amplifying transistor is turned off, and to turn off when said first amplifying transistor is turned on; and
a fourth transistor connected in parallel with said second amplifying transistor, said fourth transistor being configured to turn on when said second amplifying transistor is turned off, and to turn off when said second amplifying transistor is turned on;
said third and fourth transistors being configured to maintain said differential amplifier in an operational state while said switch circuit pre-biases said amplifier circuit.

7. The imager circuit according to claim 1, wherein said amplifier circuit comprises a switched capacitor analog amplifier.

8. The imager circuit according to claims 7, wherein said switch circuit is configured to pre-bias said amplifier circuit by:
switching off said switched capacitor analog amplifier; and
switching on said switched capacitor analog amplifier prior to said switched capacitor analog amplifier amplifying said signal representing said pixel output voltage.

9. A method of reducing noise in an imager amplifier circuit, said method comprising:
providing a signal representing a pixel output voltage;
receiving a signal representing a pixel output voltage for amplification by an amplifier circuit; and
pre-biasing said amplifier circuit prior to amplifying said signal representing said pixel output voltage such that, when said pre-biasing is performed and said signal representing said pixel output is amplified by said amplifier circuit, noise in an output of said amplifier circuit is reduced.

10. The method according to claim 9, wherein said amplifier circuit comprises a source follower transistor and said pre-bias operation comprises the additional acts of:
switching off said source follower transistor; and
switching on said source follower transistor prior to amplifying said signal representing said pixel output voltage.

11. The method according to claim 10, wherein said act of switching off said source follower transistor comprises connecting a gate of said source follower transistor to ground.

12. The method according to claim 10, wherein said pre-bias operation comprises the additional acts of:
switching off a first amplifying transistor of said differential amplifier, said first amplifying transistor being configured to amplify said signal representing a pixel image voltage;
switching off a second amplifying transistor of said differential amplifier, said second amplifying transistor being configured to amplify a signal representing a pixel reset voltage;
switching on said first and second amplifying transistors prior to said amplification of said pixel image and pixel reset voltages.

13. The method according to claim 12, wherein said pre-biasing operation further comprises the acts of:
turning on a third transistor simultaneous with turning off said first amplifying transistor, said third transistor being connected in parallel with said first amplifying transistor;
turning on a fourth transistor simultaneous with turning off said second amplifying transistor, said fourth transistor being connected in parallel with said second amplifying transistor;
turning off said third and fourth transistors when said first and second amplifying transistors are turned on.

14. The method according to claim 9, wherein said amplifier circuit comprises a switched capacitor analog amplifier and said pre-biasing operation comprises the further acts of:
switching off said switched capacitor analog amplifier circuit prior to amplification of a signal representing said pixel image voltage; and
switching on said switched capacitor analog amplifier circuit prior to amplifying said signal representing said pixel output voltage.

15. An imaging system comprising:
a CPU;
a pixel comprising structure for providing a signal representing a pixel output voltage;
an amplifier circuit for receiving a signal representing said pixel output voltage; and
a switch circuit responsive to said CPU for pre-biasing said amplifier circuit prior to amplifying said signal representing said pixel output voltage such that, when said pre-biasing is performed and said signal representing said pixel output voltage is amplified by said amplifier circuit, noise in said amplifier circuit is reduced.

16. The imaging system according to claim 15, wherein said amplifier

17. The imaging system according to claim 16, wherein said switch circuit is configured to pre-bias said amplifier circuit by:
switching off said source follower transistor; and
switching on said source follower transistor prior to said source follower circuit amplifying said signal representing said pixel output voltage.

18. The imaging system according to claim 15, wherein said amplifier circuit comprises a differential amplifier, said differential amplifier comprising
a differential circuit portion;
a first amplifying transistor coupled to said differential circuit portion and configured to receive and amplify a first signal representing said pixel image voltage; and
a second amplifying transistor coupled to said differential circuit portion and configured to receive and amplify a second signal representing said pixel reset voltage; and

19. The imaging system according to claim 18, wherein said switch circuit is configured to pre-bias said amplifier circuit by:
switching off said first and second amplifying transistors; and
switching on said first and second amplifying transistors, prior to amplifying said pixel image voltage and said pixel reset voltage.

20. The imaging system according to claim 19, wherein said differential amplifier further comprises:
a third transistor connected in parallel with said first amplifying transistor, said third transistor being configured to turn on when said first amplifying transistor is turned off, and to turn off when said first amplifying transistor is turned on; and
a fourth transistor connected in parallel with said second amplifying transistor, said fourth transistor being configured to turn on when said second amplifying transistor is turned off, and to turn off when said second amplifying transistor is turned on;
said third and fourth transistors being configured to maintain said differential amplifier in an operational state while said switch circuit pre-biases said amplifier circuit.

21. The imaging system according to claim 15, wherein said amplifier circuit comprises a switched capacitor analog amplifier.

22. The imaging system according to claims 21, wherein said switch circuit is configured to pre-bias said amplifier circuit by:
switching off said switched capacitor analog amplifier; and
switching on said switched capacitor analog amplifier prior to said switched capacitor analog amplifier amplifying said signal representing said pixel output voltage.

23. An amplifier circuit for receiving and amplifying a signal, said amplifier circuit comprising:
a switch circuit for pre-biasing said amplifier circuit prior to amplifying said signal such that, when said pre-biasing is performed and said signal is amplified by said amplifier circuit, noise in said amplifier circuit is reduced.

24. The amplifier circuit according to claim 23, wherein said amplifier circuit further comprises at least one amplifying transistor.

25. The amplifier circuit according to claim 24, wherein said switch circuit is configured to pre-bias said amplifier circuit by:
switching off said amplifying transistor; and
switching on said amplifying transistor prior to said amplifying circuit amplifying said signal.

26. The amplifier circuit according to claim 24, wherein said amplifier circuit further comprises:
a second transistor connected in parallel with said amplifying transistor, said second transistor being configured to turn on when said amplifying transistor is turned off, and to turn off when said amplifying transistor is turned on; and
said second transistor being configured to maintain said amplifier circuit in an operational state while said switch circuit pre-biases said amplifier circuit.

27. The amplifier circuit according to claim 23, wherein said switch circuit is configured to pre-bias said amplifier circuit by:
switching off said amplifier circuit; and
switching on said amplifier circuit prior to said amplifier circuit amplifying said signal.

28. A method of reducing noise in an amplifier circuit, said method comprising:
providing a signal;
receiving said signal for amplification by an amplifier circuit; and
pre-biasing said amplifier circuit prior to amplifying said signal such that, when said pre-biasing is performed and said signal is amplified by said amplifier circuit, noise in an output of said amplifier circuit is reduced.

29. The method according to claim 28, wherein said amplifier circuit comprises a amplifying transistor and said pre-bias operation comprises the additional acts of:
switching off said amplifying transistor; and
switching on said amplifying transistor prior to amplifying said signal.

30. The method according to claim 29, wherein said act of switching off said amplifying transistor comprises connecting a gate of said amplifying transistor to ground.

31. The method according to claim 29, wherein said pre-bias operation comprises the additional acts of:
turning on a second transistor simultaneous with turning off said amplifying transistor, said second transistor being connected in parallel with said amplifying transistor; and
turning off said second transistor when said amplifying transistor is turned on.

32. The method according to claim 28, wherein said pre-biasing operation comprises the further acts of:
switching off said amplifier circuit prior to amplification of a signal; and
switching on said amplifier circuit prior to amplifying said signal.
